(19) United States
(12) Patent Application Publication
(10) Pub. No.: US 2006/0042879 A1
(43) Pub. Date: Mar. 2, 2006

(54) Vertical track device for raising and lowering fixtures thereon

(76) Inventors: Kerem Tepecik, Dallas, TX (US); Dale Vith, Carrollton, TX (US)

Correspondence Address: MICHAEL L. DIAZ, P.C., 555 REPUBLIC DRIVE, SUITE 200, PIANO, TX, 75074, US

(21) Appl. No.: 10/920,943

(22) Filed: Aug. 18, 2004

(51) Int. Cl. B66B 9/02

(52) U.S. Cl. 187/250

(57) ABSTRACT

A vertical track with a slidable carriage assembly for raising and lowering selectable objects, that may easily retrofit existing poles with existing electrical wiring, is disclosed. The vertical track has a T-shaped slot, which extends the majority of the length of the face of the track. The carriage fits within the slot and the carriage extends at least partially beyond the slot to attach a selectable object. The T-shaped slot also encloses a looped cable with a pulley system and an electrical transfer bus. One side of the looped cable is attached to the bottom of the carriage. The other side of the cable travels over a pulley mounted in the upper portion of the slot, down along an interior edge of the slot over a lower pulley and returns to the top of the carriage. A detachable power source rotationally drives the lower pulley.

### BACKGROUND OF THE INVENTION

1. Technical Field of the Invention

The present invention relates to elevated support structures, and more particularly, to a mountable track and integral device for raising and lowering fixtures between an elevated position and a lower position.

2. Description of Related Art

Conventional poles and masts have long been used to gain a vantage point for various elevated objects. For example, lights, signs, antennas, relay dishes, surveillance cameras, and weather equipment have been supported above the ground. The elevated position of the equipment considerably improves the object's function, including a greater area of view with less interference by lower structures. However, the elevated objects are inherently difficult to install, maintain, and repair. Personnel are required to take risks and undergo specialized training associated with the height. Specialized equipment, such as ladders or trucks equipped with cherry pickers must be used to service the elevated objects; thus, many poles have been designed with means to raise and lower objects from the ground.

Prior known poles facilitating the raising and lowering of objects, however, have not proven fully satisfactory for a variety of reasons. The lifting devices have been very complex. Many such devices have had external moving parts exposed to the elements and exposing personnel to the hazard of the external moving parts. Specialized and unique tools have been required to drive the lifting mechanisms. Often the poles are structurally complex, costly to produce, and do not satisfy the need to retrofit existing poles with the ability to raise and lower objects.

Although there are no known prior art teachings of a device such as that disclosed herein, prior art references that discuss subject matter that bears some relation to matters discussed herein are U.S. Pat. No. 4,025,782 to Kaeser (Kaeser), U.S. Pat. No. 6,074,075 to Staniec (Staniec), and U.S. Pat. No. 6,447,150 to Jen et al. (Jen). These patents discuss poles with lifting devices.

Kaeser discloses a structurally complex lifting pole using an external winching device. A light support structure is supported by a cable system through a hollow interior of a vertical pole. The cable support system allows the raising and lowering of the suspended lights. The cable system is used by attaching a specialized, portable winch. The winch is powered by an external motor, such as a portable, battery-powered hand drill. The Kaeser pole was designed as a stand alone device, ill fitted to retrofit an existing pole.

Staniec also discloses a pole structure with a complex lifting device. Staniec's device is intended to lift a multiple light device on a high mast. This device also is ill fitted to retrofit an existing pole.

In another existing apparatus, Jen teaches a structurally complex pole. The Jen pole has a vertical channel incorporated into a side of the pole. A rotational threaded rod is mounted within the channel. A carriage that engages the rod, is driven along the vertical channel by the threaded rod. The threaded rod is connected to a detachable coupling for engaging a drive tool, such as a portable battery-powered hand drill, to rotationally drive the threaded rod. The carriage includes a mounting bracket for attachment of the supported device. A cable connecting the supported object and an external device or power source has a detachable coupling, and is carried along a pulley at the top of the elongated pole when the carriage is raised and lowered. A return spring is connected to one end of the cable to retract the free end of the cable back to the base of the pole when the supported object is raised into the elevated position. Carriage locks at the top of the pole engage the carriage in the elevated position to prevent vibration of the supported object. A stabilizer frame within the channel minimizes vibration of the threaded rod as it is rotationally driven. The pole disclosed in Jen lifts and provides electrical power to a support object. The lifting device is encased within the interior of the pole. Indeed, many known prior art devices enclose the electrical power and lifting mechanisms within a heavy and complex pole structure. Jen does not teach or suggest retrofitting an existing pole with a lifting apparatus. Jen merely disclosed a complex lifting mechanism which must be integrated within an interior portion of a pole.

Accordingly, it has been found that a need exists for a simple and effective way of raising and lowering a fixture upon a pole. In addition, a retrofit is needed that is a low cost, simple attachment to existing structures, thus saving the time and expense of replacing the existing pole and its existing electrical wiring. It is an object of the present invention to provide such an apparatus.

### SUMMARY OF THE INVENTION

In one aspect, the present invention is a slotted track to support various elevated objects. The track attaches to existing vertical support structures and existing electrical wiring. A carriage is slidably mounted within the track's slot, with at least a portion of the carriage extending outside of the slot. The selected object, such as a light fixture, is attached to the carriage. The carriage may be moved along the track by mechanism located within the track's slot. The elevated object also receives electrical power from connections within the slot.

In another aspect, the present invention is a slotted track to support various elevated objects. The slot is T-shaped. The track attaches to existing vertical support structures and existing electrical wiring. A carriage is slidably mounted within the track's slot, with at least a portion of the carriage extending outside of the slot. The selected object, such as a light fixture, is attached to the carriage. The carriage may be moved along the track by a looped cable attached to the center of the carriage. The cable runs over an upper pulley mounted within the upper portion of the slot, down along an interior edge of the slot, around a lower pulley mounted within the lower portion of the slot, and returning to the carriage. The lower pulley can be rotationally driven by an external force, such as a portable drill or ratchet driver. An electrical transfer bus consisting of two or more metallic rods are mounted vertically within and insulated from the upper portion of the track. The portion of the metallic rods extending into the slot have a tapered end. The metallic rods are connected via insulated wire to preexisting electrical wiring. Insulated metallic receptacles are mounted in the carriage and orientated to engage the taper and create contact with the respective transfer bus, when the carriage is translationally moved to the upper limits of the track. The grounding electrical transfer bus extends farther into the slot. Thus the object is grounded when the carriage is lowered.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a front view of a bracket for lifting selectable objects attached to a slidable carriage that is mounted within a vertical track in the preferred embodiment of the present invention;

FIG. 2 is a top view of a cross section of the bracket/carriage/track;

FIG. 3 is a side view of the entire track;

FIG. 4 is a partial front perspective with a cut-away view of an upper pulley mounted within the track, a positive electrical copper transfer bus, and a negative grounded electrical copper transfer bus;

FIG. 5 is a partial front perspective view of a lower pulley and cable system, mounted within the track showing a square-socket-type attachment point to drive the pulley;

FIG. 6 is a top cross sectional view of the lower pulley with the attached socket drive mounted within the track;

FIG. 7 shows a partial front perspective cut-away view of an upper pulley mounted within the track, a positive electrical copper transfer bus, and a negative grounded electrical copper transfer bus in a first alternate embodiment of the present invention;

FIG. 8 also illustrates a partial front perspective view of a lower pulley and cable system, mounted within the track showing a square-socket-type attachment point to drive the pulley;

FIG. 9 shows an a top cross sectional view of the lower pulley with the attached socket drive mounted within the track;

FIG. 10 is a front perspective view of a gasket sealing the track opening in a second alternative embodiment of the present invention;

FIG. 11 is a top cross sectional view of the track of FIG. 10;

FIG. 12 is a front perspective view of the carriage with a threaded rod mounted within the track in a third alternate embodiment of the present invention;

FIG. 13 is a top cross sectional view of the track of FIG. 9; and

FIG. 14 is a side view of the threaded rod driving mechanism of FIG. 9.

### DETAILED DESCRIPTION OF EMBODIMENTS

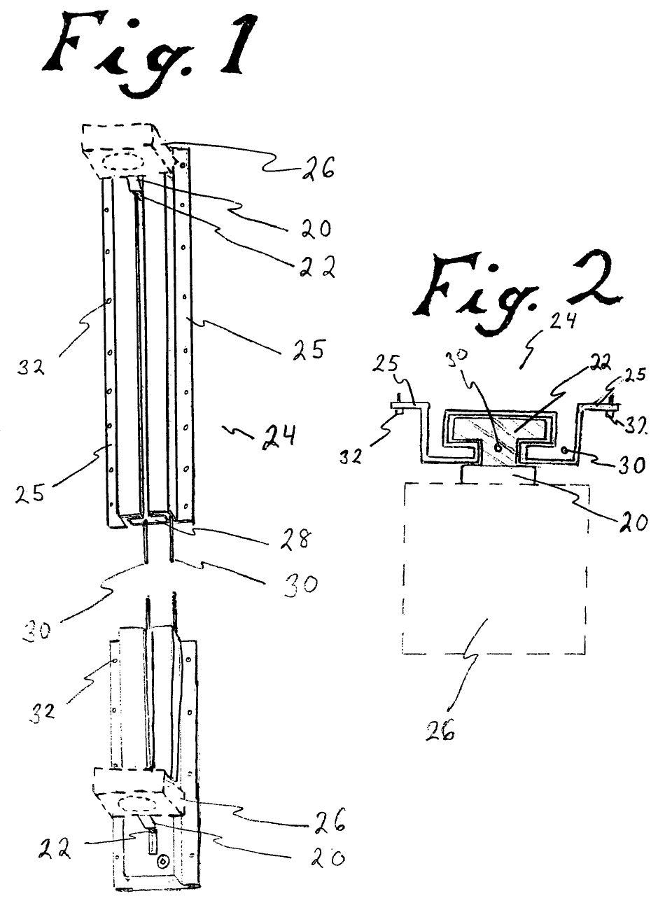

A vertical track with a slidable carriage assembly for raising and lowering selectable objects. FIG. 1 is a front view of the preferred embodiment of the present invention showing a bracket 20 that may lift a light 26 or other selectable objects attached to a slidable carriage 22 that is mounted within a vertical track 24. The bracket, carriage, and track are made of hard structural material, which may include plastics, resins, fiberglass, and metals. In the preferred embodiment, the bracket and track are metallic, while the carriage is high density plastic. The light is shown in the raised and lowered position. A T-shaped slot 28 extends the majority of the length of the face of the track. The track may be formed of folded sheet metal with flanges 25 extending from the sides of the track. A looped cable 30 is enclosed within the T-slot on a pulley system. The track is attached to a support structure, such as a pole or wall, by bolts 32 or screws. The bolts or screws are aligned through the flanges of the track along both vertical sides of the track.

FIG. 2 is a top view of a cross section of the light 26, the bracket 20, the carriage 22, and the track 24. The looped cable 30 passes through the interior space of the folded track, thereby preventing interference with the movement of the carriage within the T-slot, and the looped cable returns through the T-slot to attach to the middle of the carriage at the center of the T-slot.

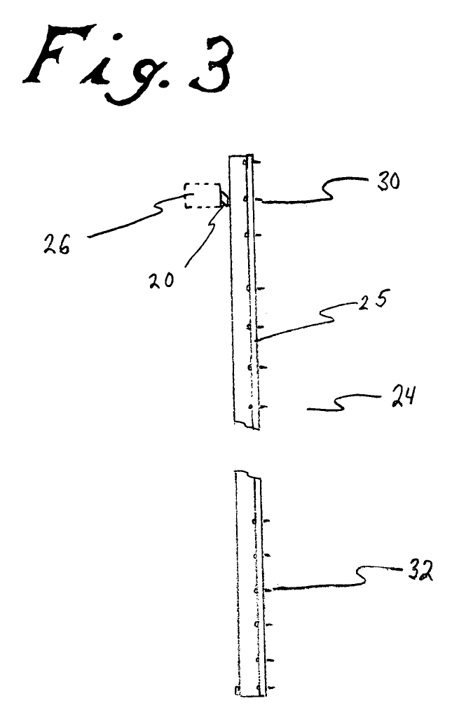

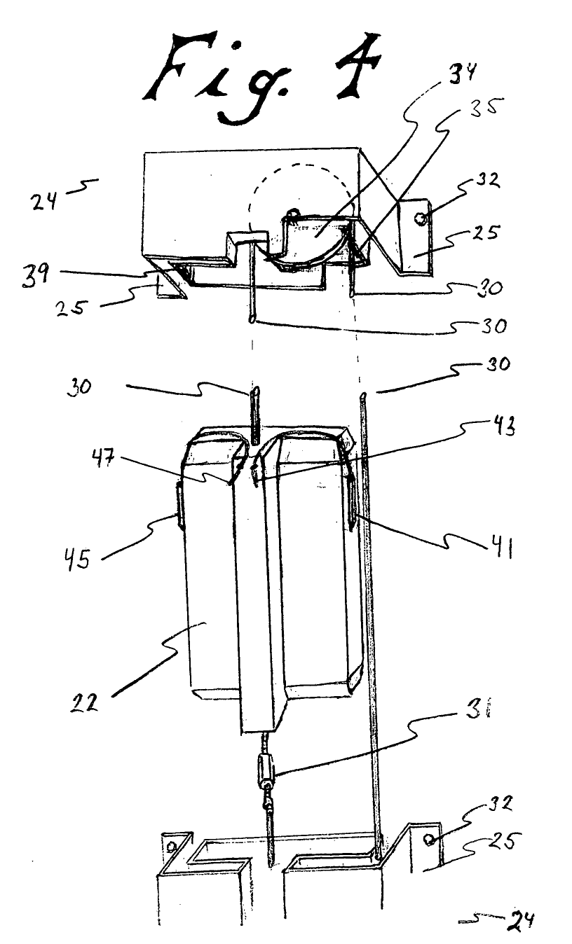

FIG. 3 is a side view of the entire track 24. The light 26 mounted on the bracket 20 is shown in the upper position. Various bolts or screws 32, shown on the face of the flange 25, extend through the flange to mount the track to a vertical surface.

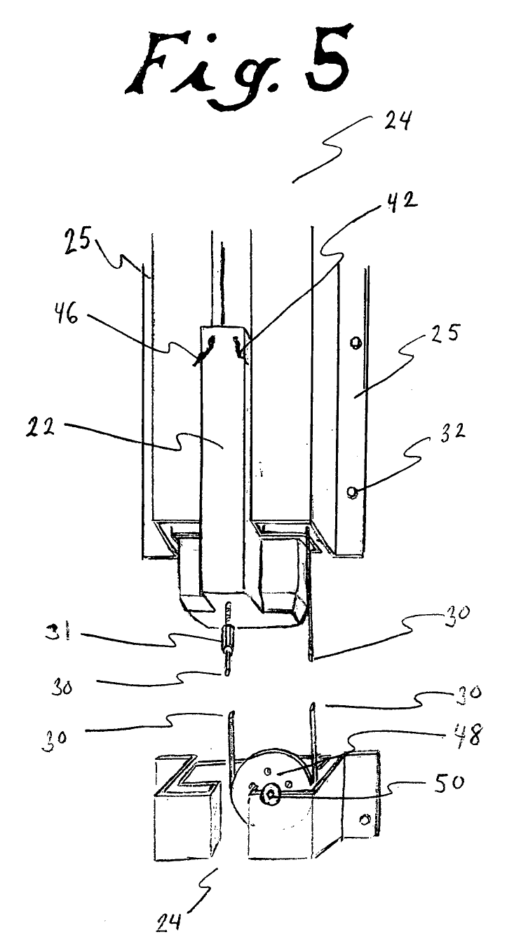

FIG. 4 is a partial front perspective with a cut-away view of an upper pulley 34 free mounted on an upper axle 33 within the track 24. The upper pulley is sized and shaped with one side of the looped cable 30 aligned and attached to the center of the upper surface of the carriage 22. The preferred composition of the carriage is high density plastic. The carriage has a preferred length of 12 to 18 inches with all corners that engage the T-slot tapered. The cable passes over the upper pulley, while the other side of the looped cable passes within the interior space of the track formed by the interior wall of the T-slot and the flange 25 returning and attaching via a turnbuckle 31 to the center of the underside of the carriage.

FIG. 4 also shows the preferred embodiment of transferring electrical power to the suspended object. A positive electrical copper transfer bus 35 is a copper plate vertically attached and insulated from an interior side wall of the T-slot. The positive electrical transfer bus is connected via insulated wire to a positive electrical source. A positive electrical tab 41 extends from a side of the carriage to make contact with the positive transfer bus. The positive transfer bus is insulated from the carriage connected via insulated wiring 43 to power the light or selectable object. A negative electrical copper transfer bus 39 is also a copper plate mounted vertically on the opposite interior T-slot wall and insulated from the upper portion of the track. However, the negative transfer bus extends a greater length down the interior wall of T-slot. The negative electrical transfer bus is connected via insulated wire to a negative electrical source. A negative electrical tab 45 extends from a side of the carriage to make contact with the positive transfer bus. The negative transfer bus is insulated from the carriage and connected via insulated wiring 47 completing an electrical circuit to power the light or selectable object. The orientation of the transfer buses and their respective electrical tabs extend from the sides of the carriage to allow the copper tabs to contact the respective transfer busses when the carriage is in the upper most position on the track. As the carriage is moved downward, the electrical tabs will break contact with the respective transfer bus. The negative transfer bus, protruding farther into the T-slot than the positive transfer bus, will maintain contact over a greater range of travel of the carriage, thereby ensuring that the object is grounded until the circuit is completely broken. The transfer busses allow the use of existing electrical power sources and save the time and expense of wiring the full length of the track. However, in an alternate embodiment of the present invention, wiring may be installed along the entire length of the track.

FIG. 5 is a partial front perspective view of a lower pulley 48, with the looped cable 30, mounted within the lower portion of the track 24. The lower pulley is sized and shaped with one side of the looped cable 30 aligned and attached via a turnbuckle 31 to the center of the underside surface of the carriage 22. The looped cable fits around the lower pulley while the other side of the looped cable passes within the interior space of the track formed by the interior wall of the T-slot and the flange 25 returning over the upper pulley 34 (reference FIG. 4) and attaching to the center of the upper surface of the carriage. The looped cable may be wrapped around the lower pulley to increase friction. A lower axle 50 protrudes through the front of the track. The lower axle is fixed to the center of the lower pulley. The lower axle also extends and mounts into the back of the track. The lower pulley axle's protrusion is cap-shaped with a center square-socket-type attachment point.

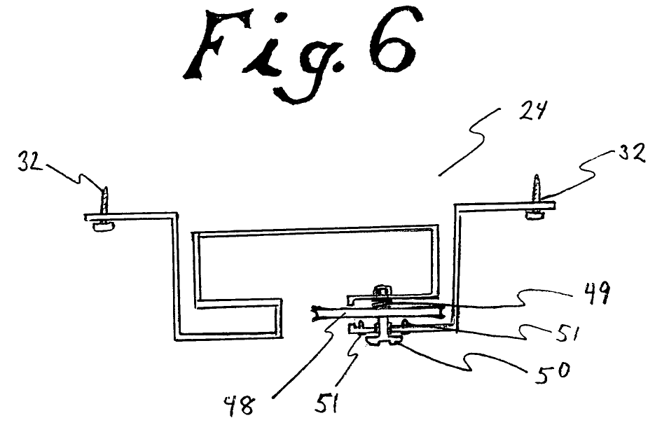

FIG. 6 is a top cross sectional view of the lower pulley 48 with the attached lower axle 50 mounted within the track 24. The lower axle is shown with its cap shaped protrusion with a center square-socket-type attachment point. A spring 49 pushes the lower axle-pulley assembly toward the front of the track. The lower pulley is preferably constructed with several holes along the lower pulley's radii (reference FIG. 5). The holes are orientated to match and engage corresponding male catches 51 from the front of the track. The preferred embodiment of the lower axle allows the lower axle a slight amount of play to move laterally fore and aft along the lower axle's center line. The spring forces the lower pulley to engage the catches and locks the lower pulley in place. Alternatively, a ratchet and corresponding pawl may be used to lock the carriage in place. A removable bolt may also be placed through the lower pulley, for additional safety.

With reference to FIGS. 1-6, the operation of the preferred embodiment of the track 24 for raising and lowering select objects will now be explained. The track may have various proportions without departing from the novel features of the present invention. The preferred track embodiment is approximately 5 inches wide and of various heights of up to approximately 30 feet. The height of the track is matched to the specific site of use. For example, many existing light poles do not have the ability to raise and lower the respective pole's lighting fixtures. In order to easily change the pole's light, a height of track would be matched to the height of the existing pole. The existing pole's light fixture is removed. The track is fixed to the existing pole by the bolts or screws 32 and the existing pole's electrical wiring is connected to the electrical transfer busses 35 and 39. A light 26 would be the selected object attached to the bracket 20 and the carriage 22. The light is electrically connected to wires 43 and 47.

Once attached and set up on the existing pole, the light 26 may be raised or lowered by a hand rachet, a powered rachet, a hand drill with a socket attachment, or other suitable motor source that is positioned within the square-socket-type attachment point of the lower axle 50. The lower axle is pushed inward, overcoming the spring 49 and disengaging the male catches 51. By rotationally driving the lower pulley in a clockwise or a counter clockwise direction, the carriage is respectively driven up or down the track by the looped cable 30. When the carriage reaches the upper limits of the track, the electrical transfer busses 35 and 39 engages the respective tabs 41 and 45 on the carriage, thus powering the light. The spring is allowed to push the lower pulley toward the front of the track and lock the carriage in place.

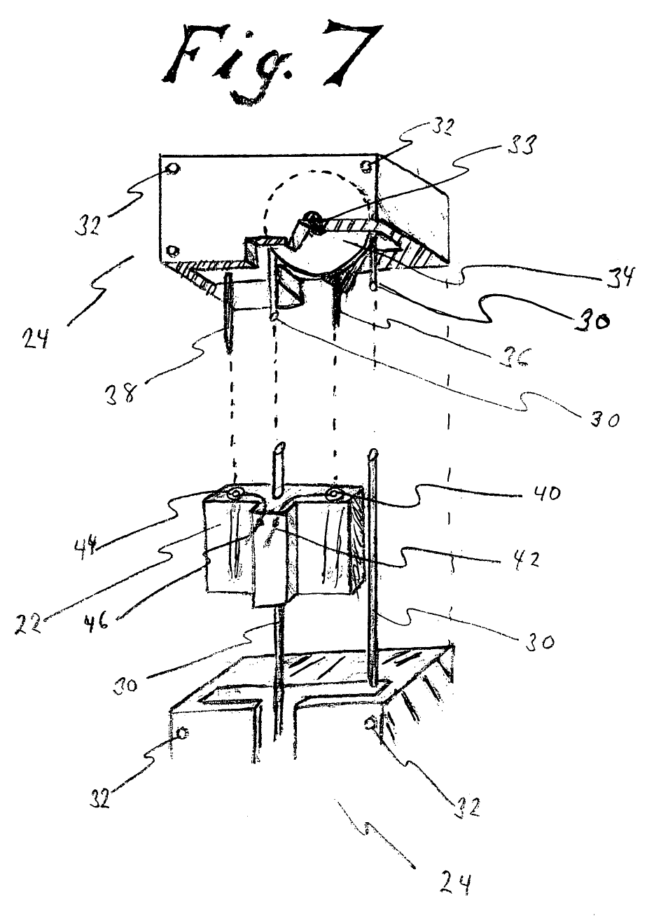

FIG. 7 is a front perspective of an alternative embodiment of the present invention showing a cut-away view of an upper pulley 34 free mounted on an upper axle 33 within the track 24. The upper pulley is sized and shaped with one side of the looped cable 30 aligned and attached to the center of the upper surface of the carriage 22. The cable passes over the upper pulley and the other side of the looped cable passes between the carriage and the corresponding wall of the track, returning and attaching to the center of the underside of the carriage.

FIG. 7 also shows an alternate means of transferring electrical power to the suspended object. A positive electrical copper transfer bus 36 is a copper rod suspended vertically and insulated from the upper portion of the track. The positive electrical transfer bus is connected via insulated wire to a positive electrical source. The lower portion of the exposed copper electrical transfer bus is tapered to fit in an insulated positive copper receptacle 40. The positive receptacle is mounted vertically within the carriage and connected via insulated wiring 42 to power the light or selectable object. A negative electrical copper transfer bus 38 is also a copper rod suspended vertically within the T-slot and insulated from the upper portion of the track. However, the negative transfer bus preferably extends into the T-slot a greater length than the positive transfer bus. The negative electrical transfer bus is connected via insulated wire to a negative electrical source. The negative transfer bus is also tapered and opposed to a negative copper receptacle 44. The negative receptacle is mounted vertically within the carriage and connected via insulated wiring 46, allowing the completion of a circuit to power the light or selectable object. The orientation of the transfer buses and their respective receptacles allows the copper rods to fit within and contact the receptacles of the carriage, when the carriage is in the upper most position on the track. As the carriage is moved downward, the transfer buses slide out of the receptacles. As the carriage traverses the track downward, the negative transfer bus is the last contact to be broken. Thus, the object will be grounded until the circuit is fully broken. The transfer busses allow the use of existing electrical power sources and save the time and expense of wiring the full length of the track. However, in another alternate embodiment of the present invention, wiring may be installed along the entire length of the track.

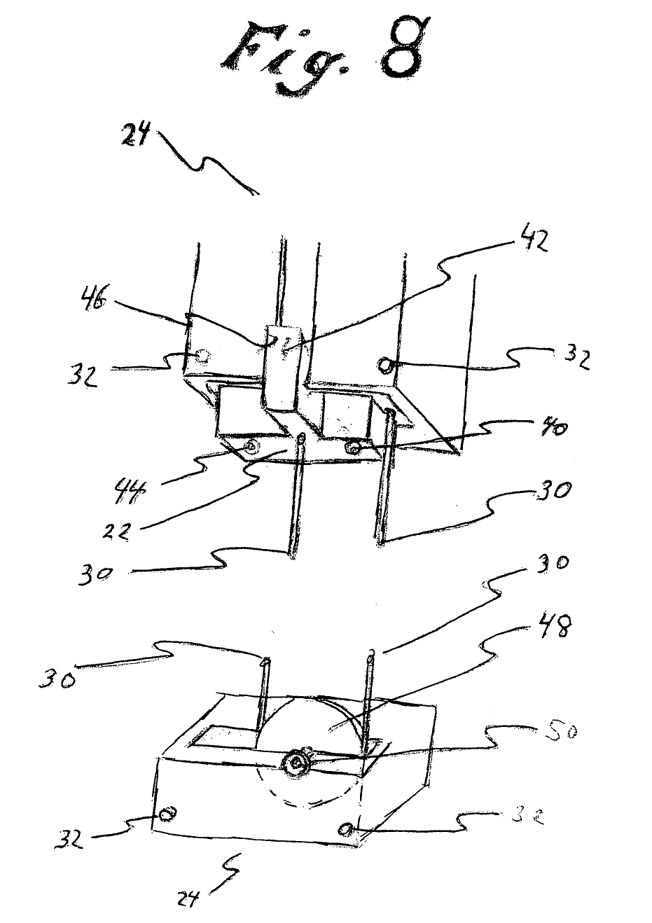

FIG. 8 is an alternative embodiment of the present invention showing a front perspective view of a lower pulley 48, with the looped cable 30, mounted within the lower portion of the track 24. The lower pulley is sized and shaped with one side of the looped cable 30 aligned and attached to the center of the underside surface of the carriage 22. The looped cable is positioned around the lower pulley, and the other side of the looped cable passes between the carriage and the corresponding wall of the track returning over the upper pulley 34 (reference FIG. 7) and attaching to the center of the upper surface of the carriage. The looped cable may be wrapped around the lower pulley to increase friction. A lower axle 50 protrudes through the front of the track on bushings or bearings. The lower axle is fixed to the center of the lower pulley. The lower axle also extends and mounts into the back of the track on a bearing or bushing surface. The lower pulley axle's protrusion is cap-shaped with a center square-socket-type attachment point.

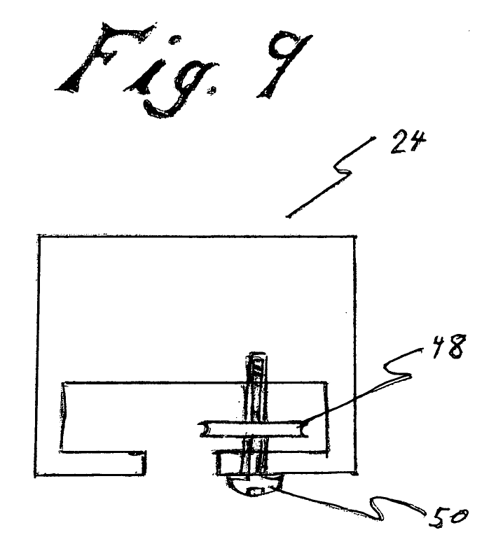

FIG. 9 is a top cross sectional view of the lower pulley 48 with the attached lower axle 50 mounted within the track 24. The lower axle is shown with its cap shaped protrusion with a center square-socket-type attachment point. The lower axle has bushing or bearing mounts where the lower axle passes through the front of the track and where the axle mounts into the back of the track.

The electrical transfer busses are shown with a positive and negative connection. In an alternate embodiment, more transfer busses and opposing tabs or receptacles may be utilized in the present invention to allow a plurality of electrical wiring possibilities to meet the requirements of various selected elevated objects.

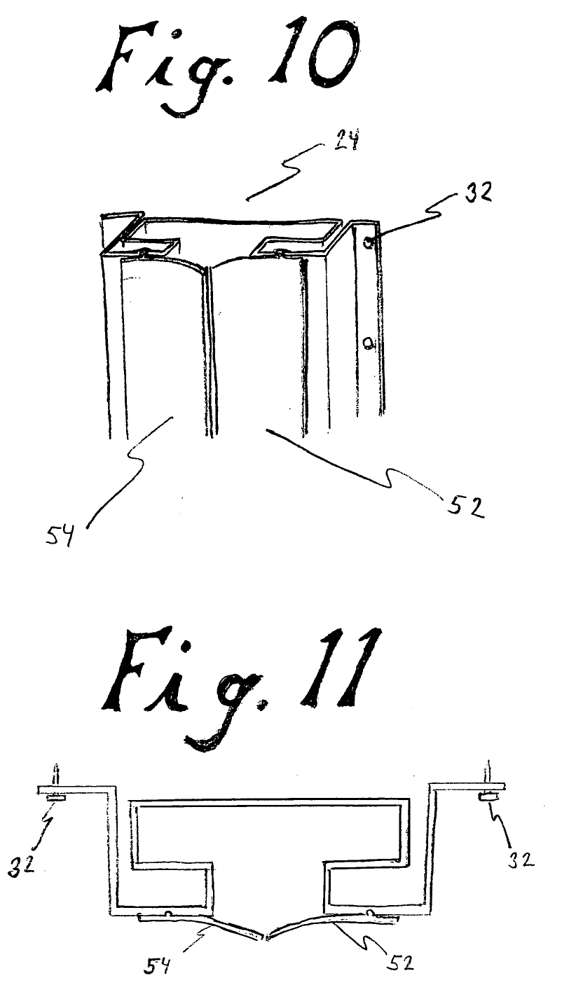

FIG. 10 is a front perspective view of a right gasket 52 opposing a left gasket sealing the T-slot opening of the track 24 in a first alternate embodiment of the present invention. FIG. 11 is a top cross sectional view of the track 24 with right gasket 52 and left gasket 54. The gaskets may be formed of a flat elastic plastic or rubber with a raised attached bead. The bead may be positioned into a grove on the front of the track as illustrated. The gaskets may forgo the raised bead and be attached to the track by extending under the screws or bolts 32. The gasket are intended to prevent foreign matter from entering the T-shaped slot and bend outwardly to allow the carriage 22 to pass through the slot. Similarly, the gaskets may be built with a left and right stiff hair like projections that cover the slot opening and bend upwardly or downwardly to allow the passage of the carriage and then spring back to cover the slot.

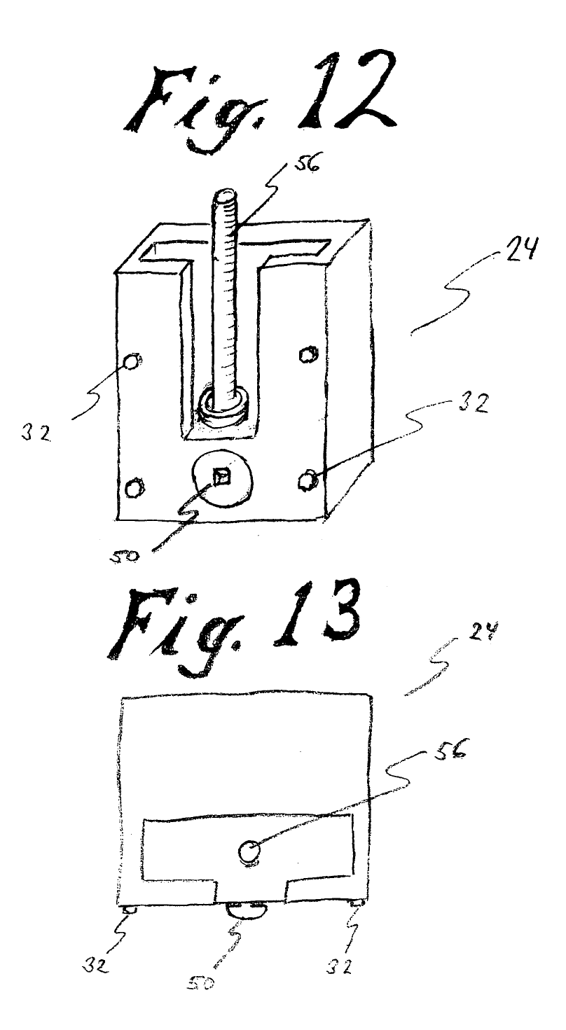

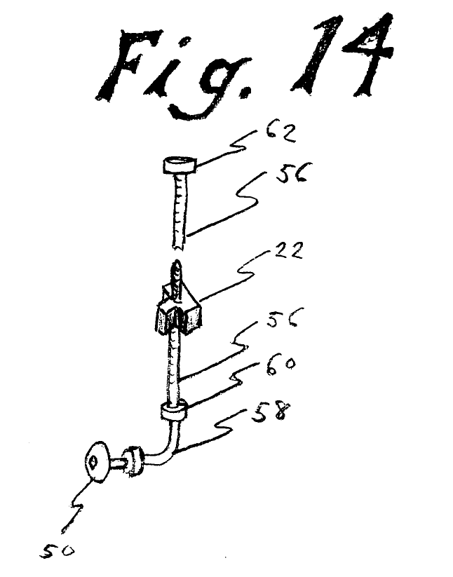

Still another embodiment of the present invention is shown in FIGS. 12-14. FIG. 12 shows a front perspective view of an alternative embodiment of the track 24 using a threaded rod 56 mounted within the track to drive the carriage 22. FIG. 13 is a top cross sectional view of the track 24 with the alternative threaded rod 56 embodiment. FIG. 14 is a side view of the alternative threaded rod driving mechanism. The lower axle 50 with the square-socket-type connection extends through the front of the track on a bearing or bushing surface. The lower axle is connected to a flexible shaft 58 or u-joint to the bottom of the threaded rod. The bottom of the threaded rod is supported by a bearing or bushing 60 attached to the bottom of the track and located within the T-slot. The threaded rod extends the length of the track through the carriage 22. The center portion of the carriage is threaded to accept the threaded rod. The top of the threaded rod is attached by a bushing or bearing 62 to the top of the track.

Alternatively, rather than retrofitting existing poles, the present invention may be incorporated into any pole. The present invention may be integrated directly into the pole. All the inner mechanisms of the present invention are installed within the bracket rather than the interior of the pole, thereby simplifying and reducing the cost of producing an elevating support structure.

It is thus believed that the operation and construction of the present invention will be apparent from the foregoing description. While the device shown and described has been characterized as being preferred, it will be readily apparent that various changes and modifications could be made therein without departing from the scope of the invention as defined in the following claims.

What is claimed is:

1. A track attachment for supporting an object in an elevated position upon a substantially vertical support, comprising:
a track having a top and a bottom, with a slot extending at least partially between said top and said bottom;
means to attach said track to a vertical support structure;
a carriage translationally mounted within said slot, with at least a portion of said carriage extending outside of said slot;
means enclosed within said track to move said carriage vertically along said slot; and
means to attach the elevated object to said carriage.

2. The track attachment of claim 1, wherein the vertical support includes electrical wiring and further comprising means enclosed within said track to provide electrical power from the preexisting wiring to the elevated object.

3. The track attachment of claim 1 wherein said means enclosed within said track to move said carriage vertically along said slot comprises:
a closed loop cable enclosed within said slot, with said cable attaching to the upper and lower center of said carriage in the middle of said slot;
an upper pulley engaging said cable, free mounted on an upper axle in the upper end of said slot, said upper pulley sized and orientated to align a first side of said cable with the upper center of said carriage and aligning a second side of said cable between the enclosed edge of said slot and the edge of said carriage;
a lower pulley engaging said cable, said lower pulley sized and orientated to align the first side of said cable with the lower center of said carriage and aligning the second side of said cable between the enclosed edge of said slot and the edge of said carriage corresponding to the cable return from said upper pulley; and
a lower axle affixed through the center of said lower pulley and having a protrusion through a lower front of said track;
the protrusion of said lower pulley axle providing a means to attach a rotational power source for driving said lower pulley.

4. The track attachment of claim 3 wherein the protrusion of said lower axle has a center square-socket-type attachment point.

5. The track attachment of claim 1 wherein said means enclosed within said track to provide electrical power from the preexisting wiring to the elevated object comprises:
a positive electrical transfer bus having a metallic plate suspended vertically along a first interior upper edge of said slot and insulated from the upper portion of said track, said positive electrical transfer bus connecting via insulated wire to the preexisting positive electrical wiring;
a positive metallic tab installed along a first vertical edge of said carriage and insulated from said carriage and connecting via insulated wire through said carriage and said means to attach the object to said carriage, thereby connecting a positive electrical path to the object;
said positive tab being shaped and orientated to engage and create contact with said positive transfer bus, when said carriage is translationally moved to an upper limit of said track;
a negative electrical transfer bus having a metallic plate vertically suspended along a second interior upper edge and insulated from said upper portion of track, said negative electrical transfer bus connecting via insulated wire to said preexisting negative electrical wiring, the lower portion of said negative transfer bus extending to a greater length down the interior side of said slot than said positive transfer bus;
a negative metallic tab installed along a second vertical edge of said carriage within and insulated from said carriage and connecting via insulated wire through said carriage and said means to attach said object to said carriage, thereby connecting a negative electrical path to the object; and
said negative tab being shaped and orientated to engage and create contact with said negative transfer bus when said carriage is translationally moved to the upper limits of said track.

6. The track attachment of claim 1 wherein said slot opening is covered by a gasket.

7. The track attachment of claim 6 wherein said gasket comprises:
a first sheet of elastic material mounted on a first side of the face of said track such that said first sheet partially covers said slot;
a second sheet of elastic material mounted on a second side of the face of said track such that said second sheet covers the remaining opening of said slot and contacts the edge of said first sheet; and
said sheets bending outwardly away from said the opening of said slot opening allowing an unhampered movement of said carriage along said track and upon passage of said carriage returning to cover said slot opening.

8. The track attachment of claim 6 wherein the gasket comprises:
a first flat gasket mounted on a first side of the face of said track;
said first gasket having a first plurality of comb fingers, said comb fingers extending and covering a portion of said slot opening; and
a second flat gasket mounted on a second side of the face of said track opposed to said first gasket;
said second gasket also having a second plurality of comb fingers, said comb fingers extending and covering a slot opening left exposed by said first gasket;
whereby said first and second plurality of comb fingers bending upwardly or downwardly, allowing an unhampered movement of said carriage along said track and upon passage of said carriage returning to cover said slot opening.

9. The track attachment of claim 1 wherein said means enclosed within said slot to move said carriage vertically along said slot comprises:
a threaded rod rotationally mounted within said slot, said threaded rod being connected to a detachable coupling for engaging a drive tool; and
said carriage in engagement with said threaded rod, whereby rotation of said rod imparts translational movement upon said carriage through said slot.

10. The track attachment of claim 9 wherein said means enclosed within said slot to provide electrical power from said preexisting wiring to said elevated object comprises:
a positive electrical transfer bus having a metallic rod suspended vertically in an interior of said slot and insulated from the upper portion of said track, said positive electrical transfer bus connected via insulated wire to said preexisting positive electrical wiring and the lower portion of said positive transfer bus being exposed and tapered;
a positive metallic receptacle installed within and insulated from said carriage and connected via insulated wire through said carriage and said means to attach said object to said carriage, connecting a positive electrical path to said object;
said positive receptacle being shaped and orientated to engage the taper and create contact with said positive transfer bus when said carriage is translationally moved to the upper limits of said track;
a negative electrical transfer bus having a metallic rod vertically suspended into the interior of said slot from the upper portion of said track, said negative electrical transfer bus connected via insulated wire to said preexisting negative electrical wiring, the lower portion of said negative transfer bus extending to a greater length into the interior of said slot than said positive transfer bus, and the lower portion of said negative transfer bus being exposed and tapered;
a negative metallic receptacle installed within and insulated from said carriage and connected via insulated wire through said carriage and said means to attach said object to said carriage, connecting a negative electrical path to said object; and
said negative receptacle being shaped and orientated to engage the taper and create contact with said negative transfer bus when said carriage is translationally moved to the upper limits of said track.

11. A track attachment to for supporting an object in an elevated position, comprising:
a track having a top and a bottom with a T-shaped slot extending at least partially between said top and said bottom;
means to attach said track to a vertical support structure;
a carriage translationally mounted within said slot with at least a portion of said carriage extending outside of said slot;
a closed loop cable enclosed within said slot with said cable attached to the upper and lower center of said carriage in a middle of said slot;
an upper pulley engaging said cable, free mounted on an upper axle in the upper end of said slot, said upper pulley sized and orientated to align a first side of said cable with an upper center of said carriage and aligning a second side of said cable between an enclosed edge of said slot and the edge of said carriage;
a lower pulley engaging said cable, said lower pulley sized and orientated to align the first side of said cable with a lower center of said carriage and aligning the second side of said cable between the enclosed edge of said slot and the edge of said carriage corresponding to the cable return from said upper pulley;
a lower axle affixed through the center of said lower pulley, with said lower axle mounted into a lower back of said track and said lower axle protruding through a lower front of said track on a bearing or bushing mount;
the protrusion of said lower pulley axle providing a means to attach a rotational power source for driving said lower pulley and a carriage translationally mounted within said slot with at least a portion of said carriage extending outside of said slot;
a means to attach the elevated object to said carriage;
a positive electrical transfer bus having a metallic rod suspended vertically in the interior of said slot and insulated from the upper portion of said track, said positive electrical transfer bus connected via insulated wire to the preexisting positive electrical wiring and the lower portion of said positive transfer bus being exposed and tapered;
a positive metallic receptacle installed within and insulated from said carriage and connected via insulated wire through said carriage and said means to attach said object to said carriage, thereby connecting a positive electrical path to said object,
said positive receptacle being shaped and orientated to engage the taper and create contact with said positive transfer bus when said carriage is translationally moved to the upper limits of said track;
a negative electrical transfer bus having a metallic rod vertically suspended into the interior of said slot from the upper portion of said track, said negative electrical transfer bus connected via insulated wire to said preexisting negative electrical wiring, the lower portion of said negative transfer bus extending to a greater length into the interior of said slot than said positive transfer bus and the lower portion of said negative transfer bus being exposed and tapered;
a negative metallic receptacle installed within and insulated from said carriage and connected via insulated wire through said carriage and said means to attach said object to said carriage, thereby connecting a negative electrical path to said object; and
said negative receptacle being shaped and orientated to engage the taper and create contact with said negative transfer bus when said carriage is translationally moved to the upper limits of said track.

12. The track attachment of claim 11 wherein the protrusion of said lower axle has a center square-socket-type attachment point.

13. The track attachment of claim 12 wherein said slot opening is covered by a gasket.

14. The track attachment of claim 13 wherein said gasket comprises:
a first sheet of elastic material mounted on a first side of the face of said track such that said first sheet partially covers said slot; and
a second sheet of elastic material mounted on a second side of the face of said track such that said second sheet covers the remaining opening of said slot and contacts an edge of said first sheet;
said sheets bending outwardly away from said slot opening, allowing an unhampered movement of said carriage along said track and upon passage of said carriage return to cover said slot opening.

15. The track attachment of claim 12 wherein the gasket comprises:
a first flat gasket mounted on a first side of a face of said track;
said first gasket having a first plurality of comb fingers extending and covering part of said slot opening;
a second flat gasket mounted on a second side of the face of said track opposed to said first gasket;
said second gasket having a second plurality of comb fingers extending and covering the slot opening left exposed by said first gasket; and
said comb fingers bending upwardly or downwardly, allowing the unhampered movement of said carriage along said track and upon passage of said carriage returning to cover said slot opening.

16. A vertical support having a raisable object, said vertical support comprising:
a substantially vertical support;
a track attached to said vertical support, said track running a length of said vertical support and having a slot within the length of said track;
a carriage movable within the slot, said carriage holding the object;
a pulley assembly for moving said carriage up and down along the length of said track, said pulley assembly positioned within said track; and
a motor for driving said pulley assembly;
whereby said motor drives said pulley assembly to raise and lower said movable carriage within the slot.

17. The vertical support of claim 16 wherein the vertical support is a pole and the object is a light assembly.

18. The vertical support of claim 16 further comprising an electrical system providing power to the light assembly, said carriage having a disconnectable power connector between a power source providing power to the light assembly and the light assembly, whereby the power connect is disconnected when lowering said carriage downwardly.

19. The vertical support of claim 16 wherein said motor is a motorized tool inserted into a fitting affixed said vertical support for driving said pulley assembly.

20. The vertical support of claim 16 wherein said pulley assembly includes a plurality of pulley wheels driving a belt connected to the carriage.
